(19) United States
(12) Patent Application Publication
(10) Pub. No.: US 2002/0171927 A1
(43) Pub. Date: Nov. 21, 2002

(54) Aerial image illumination system

(76) Inventor: Alfred C. Barnes III, San Marcos, CA (US)

Correspondence Address: HIGGS, FLETCHER & MACK LLP, 2600 FIRST NATIONAL BANK BUILDING, 401 WEST "A" STREET, SAN DIEGO, CA, 92101-7910, US

(21) Appl. No.: 09/800,533

(22) Filed: Mar. 6, 2001

Related U.S. Application Data
(60) Provisional application No. 60/250,589, filed on Nov. 30, 2000.

(51) Int. Cl. G03B 21/56

(52) U.S. Cl. 359/451

(57) ABSTRACT

An aerial image projection system is provided for use on an airship, balloon, or other inflatable structure which obtains its lift from gas or hot air, and may be used for advertising or other video projection and display. A defined surface area of the envelope of the inflatable structure serves as the projection screen for receiving a video image effective for viewing from a location external to the inflatable structure. A projector apparatus is mounted to the exterior framework or envelope opposite the projection screen for projecting a video image through a window in the envelope and through the interior of the inflatable structure to the opposing projection screen. The projector apparatus utilizes a projector array for establishing the required illumination for viewing long distances.

This application claims the priority of U.S. provisional application Serial No. 60/250,589, filed Nov. 30, 2000. As such, the specification of the above mentioned U.S. provisional application is incorporated herein by reference in full.

This invention relates to an aerial image projection system for use on an airship, balloon, or other inflatable structure such as may be used for advertising or other video display, having a projector apparatus for projecting a video image through the structure and onto a defined surface area opposite the projector apparatus.

### BACKGROUND

Heretofore, advertising or other subject-matter displayed from a hot air or gas balloon has been in the form of a projection system mounted within the interior of the inflatable structure and projecting images outward toward the outer walls of the inflatable structure. This concept is reflected in a 1986 U.S. Pat., No. 4,597,633, issuing to Fussell and entitled Image Reception System, and a 1950 U.S. Pat., No. 2,592,444, issuing to Matelena and entitled Inflatable Aerial Projection Display Device. As such, it is difficult to troubleshoot or remove the components of the projection device without deflating the structure, which in the case of a gas filled structure translates into undesirable expense.

One early American display system describes a projection system mounted outside the inflatable device or balloon for projecting an image on the outside walls of the device or on screens mounted thereto. This concept is reflected in a 1912 U.S. Pat., No. 1,013,342, issuing to Wankmuller and entitled Means for Signaling From Airships and the Like. This system is heavy and limited by the size of the screen which may be mounted to the device. Additionally, it would be impracticable for use on an airship due to its shape and size.

It appears that the above technology has not been applied to airships or other inflatable structures having a much larger surface display area. Among other reasons, high power ultra-light weight projectors have not been and are still not commercially available to satisfy the illumination requirements for such a configuration. Instead, the current technology for airship displays have migrated to computerized electronic display or light boards which may be mounted on one or each side of the airship. These display boards utilize hundreds of lamps or light-emitting diodes (LEDs) which are turned on or off to create the desired image. This process can be automated by developing computer programs to display corporate logos, messages and simple animations. One manufacture of such a system is Global Skyship Industries. In other systems, the lamps or LEDs are replaced with end-lit fiber optic cables arranged in a matrix and individually illuminated to produce a pixel-like image or display. Because these systems utilize a large matrix of light emitting devices, they are not acceptable for real-time or pre-recorded video projection, and are more suitable for use in displaying stationary graphics and scrolled text. Further, the weight of the lamps, cabling, and other onboard electronic components limit the projection display area and make these systems very heavy and undesirable for many airship applications. It will also be apparent that the operation of these display devices involves considerable expense.

### SUMMARY OF THE INVENTION

It is therefore a primary object of this invention to provide an aerial image projection system in which moving video images are produced and projected in real-time or pre-recorded formats and made to appear on the outer surface of an inflatable structure.

It is another object of this invention to provide an aerial image projection system in which video images are projected onto the surface of an inflatable structure from a projection source which is isolated from the interior of the structure so as to be removable from the structure without requiring deflation of the structure.

It is an object of this invention to provide an aerial image projection system which utilizes the envelope of the inflatable structure as the projection screen rather than a separate display panel, thereby minimizing the amount of cabling and weight of the inflatable structure.

These and other objects are achieved in accordance with the present invention by providing an aerial image projection system for use on an airship, balloon or other inflatable structure having a flexible translucent material forming an inflatable volume. The airship, balloon or other inflatable structure may be enclosed or partially enclosed, may be of a variety of shapes and sizes, and may be filled with heated air or a gas which is lighter than area to give sufficient lift into the air. A predetermined surface area on one or more sides of the inflatable volume defines a projection screen(s) for receiving a video image effective for viewing from a location external to the airship, balloon or inflatable structure. For each projection screen, a transparent window is formed in the envelope of the airship or balloon, or other flexible material and positioned on the surface opposite the corresponding projection screen. A projection apparatus, which may include an array of projector heads, is aligned to the exterior of each transparent window for projecting a video image through the interior of the airship, balloon, or other inflatable volume and onto the corresponding projection screen. The projector apparatus can be driven by computer or video transmission, or other similar means.

Due to the large display area of the projection screen(s), which may extend well over 50% of the surface area of a large airship, as well as the desired distance that the display must be visible from the ground, the illumination power of commercially available light-weight projectors is insufficient to produce the necessary illumination for use in this environment. Accordingly, a grouping or array of currently available projectors are arranged to function together to create a brighter and more suitable video image display. This is accomplished using two different concepts known as the composite image array concept and the stacked image array concept. Either or both of these concepts may be used to accomplish the objectives of the present invention.

The composite image array concept is best described as two or more projector heads oriented such that each of the projector heads projects a predetermined portion of an image at a predetermined area of the corresponding projection screen, such that a complete seamless image is formed when each of the portions of the image are projected from all of the projector heads. A digital video processor is utilized for digitally sectioning the video signal input into the desired number of signals corresponding to a particular image portion for use by each projection head.

The stacked image array concept is best described as two or more projector heads oriented such that each of the projector heads projects an identical image at an identical location on the projection screen. A splitter and amplifier is utilized for splitting the video signal input into the desired number of signals corresponding to the number of projector heads.

Finally, the projection apparatus may be enclosed to protect the assembly and components by an inflatable pressurized protective housing.

Further detail regarding the construction of the image projection system in accordance with the present invention may be had with reference to the detailed description which is provided below, taking in conjunction with the following illustrations.

### DESCRIPTION OF THE DRAWINGS

FIG. 1 illustrates a side view of the port side of an airship envelope, and more particularly the surface area defining the port side projection screen and the orientation of the starboard side projection apparatus;

FIG. 2 shows a side view of a projector apparatus as it is mounted on an airship envelope/hull, and particularly showing the pressurized protective housing surrounding said projector apparatus;

FIG. 3 illustrates cross-sectional plan view of an airship structure showing the longitudinal area of the port side and starboard side projection screens and corresponding projection apparatus;

FIG. 4 illustrates a cross-sectional view of an airship envelope showing the transverse area of the port side and starboard side projection screens, and showing the orientation of the corresponding projection apparatus;

FIG. 5 is an isometric view showing the dimensions of the projection screen and the relationship in distance between the projection apparatus and the projection screen;

FIG. 6 is an isometric view of a projection apparatus utilizing a composite image array wherein a video signal input is parsed into four sections, each section being projected by a separate projector head to a particular quadrant of the projection screen, resulting in a seamless and brighter image on the projection screen;

FIG. 7 is an isometric view of a projection apparatus utilizing a stacked image array wherein a video signal input is split into four identical video signals, each signal being projected by a separate projector head to the entire projection screen surface, resulting in a brighter image on the projection screen;

FIG. 8 is a perspective view of a second embodiment of the present invention as adapted to a hot air balloon; and

FIG. 9 is a perspective view of a third embodiment of the present invention as adapted to a tethered gas filled balloon.

### DESCRIPTION OF THE PREFERRED EMBODIMENT

Initially referring to FIG. 1, an image projection system 10 of the present invention is shown in one typical environment for use on an airship. It is to be understood that the present invention anticipates many other applications and environments, such as for use on a hot air or gas balloon, or other inflatable structure. As used herein, “airship” is defined as a lighter-than-air aircraft having a propelling system and a means for controlling the direction of motion, and which derives its lift from hot air or gas. The configuration of the airship in FIG. 1 has approximate dimensions of 130 feet long by 39.5 feet in diameter, and includes an envelope 12 or elongated bag which contains the gas or hot air in the airship. The size of the airship is relative and given only for an understanding of the relationship between components, and is not to be construed as a limitation of the present invention. Throughout this disclosure, the envelope 12 may be used interchangeably with the term hull, which is the main structure of an airship consisting of a covered elongated portion 14 which encloses the gas or air bags and supports the passenger car 16 other equipment. The direction of movement of the airship is controlled by a port side fin 18 and starboard fin (not shown) located opposite the nose end 24 and near the rear end 26 of the airship, and are commonly available from various manufacturers.

The envelope 12 of the airship is formed of a translucent material capable of performing its primary intended function of containing the gas or hot air to give the proper lift, and serves a secondary and dual purpose of defining a desired projection area or projection screen 28 for receiving and projecting video or “television like” images. In the preferred embodiment, a projection screen 28 is located on both the port side 20 and the starboard side 22 of the airship.

The envelope 12 of the present invention is preferrably made from a polyester material manufactured by Dupont under the name T68. This particular material was chosen due to its strength characteristics and ability to withstand high temperatures over time without degradation. It is the intent of the present invention to operate at temperatures in excess of 300 degrees farenhite at pressures as much as .2.5 inches W.C. (water column). Accordingly, a material that can withstand these conditions for 500 to 1,000 flight hours is preferred. However, there are a variety of other materials such as nylon and Tedlar (tm) that would also be effective in producing the desired effects of the present invention.

The size and shape of the projection area is preferably 55 feet in length and 30 feet in height on an airship having the above mentioned dimensions. However, the size or area of the screen may be larger or smaller and is adjustable according to the size of the ship and desired distance at which is display will be viewed. The preferred display provides clear visibility for an approximate one mile radius.

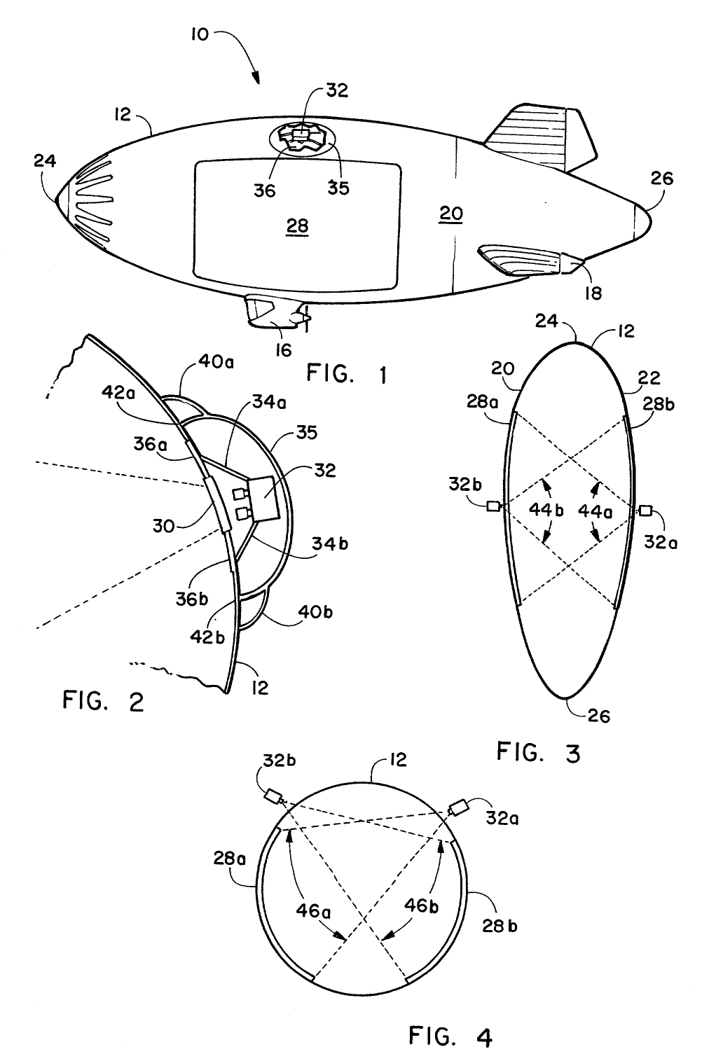

Referring again to FIG. 1 and FIG. 2, a transparent window 30 is formed in the envelope 12 for allowing the projection of images from a projector apparatus 32 to pass through the envelope 12 substantially unaltered. The window may be made of a commercially available glass or plastic material and may be sewn, glued, or otherwise attached directly into the envelope 12. The preferable size and orientation of the window 30 is approximately 2 feet by 2 feet and is located just above the projection screen 28. It is to be understood that any window size or orientation is acceptable so long as it does not interfere with the desired projection or viewing of images on the projection screen 28.

Referring now to FIG. 2, the projector apparatus 32 is completely isolated from the interior of the airship and is therefore mounted external to the envelope 12. More specifically, the projector apparatus 32 is attached to the hull 14 by way of mounting plates 36a,b glued, sewn, buckled or otherwise attached to the exterior of the envelope, and adjustable support brackets 34a,b. The orientation of the projector apparatus 32 may be altered by adjusting the length and angle of brackets 34a,b, or other adjusting means, to allow for proper and effective projection of video images onto the projection screen 28 located on the opposing side of the airship. The projector apparatus 32 receives a video image input from a data cable (not shown) routed on the exterior/interior of the envelope 12 to the passenger car 16.

As shown in FIG. 2, a pressurized protective housing 38 is designed to automatically inflate around the projection apparatus 32 prior to the inflation of the airship envelope 12. This prevents the large airship structure from forcing or bumping the projection apparatus 32 against hard surfaces and thereby destroying the valuable components of the projection apparatus 32. The housing 38 may be inflated manually or automatically driven by a separate motor located near the projection apparatus 32. Smaller pressurized protective housings 40a,b located adjacent the seam 42a,b near base plates 36a,b serve a similar function and prevent wear and tear of the envelope 12 structure as the housing 38 moves about the base plates 36a,b.

Now turning to FIG. 3, the longitudinal projection area of the port side 20 and starboard side 22 projection screens 28a,b are shown with their corresponding projection apparatus 32a,b. For example, the starboard side projection apparatus 32a projects a video image horizontally at an angle 44a, which passes through the transparent window 30 (not shown) and onto the projection screen 20. The images received by the projection screen 20 are effective for viewing from a location external to the airship. Similarly, the port side projection apparatus 32b projects a video image horizontally at an angle 44b, which passes through the transparent window 30 (not shown) and onto projection screen 22. In the preferred embodiment, angles 44a,b are approximately 90 degrees, however other angles may be used as desired.

The orientation of the projection apparatus 32a,b with respect to the port side and starboard side projection screens 28a,b, as well as its downwardly directed vertical projection area 46a,b is best shown in cross-sectional view of FIG. 4. More particularly, the starboard side projection apparatus 32a projects a video image at an vertical projection angle 46a, which passes through the transparent window 30 (not shown) and onto the projection screen 28a. Similarly, the port side projection apparatus 32b projects a video image at an vertical projection angle 46b, which passes through the transparent window 30 (not shown) and onto projection screen 28b. In the preferred embodiment, angles 46a,b are approximately 45 degrees, however other angles may be used as desired. The angles 46a,b may be adjusted by altering the projection lenses, adding alignment lenses, or by re-digitizing the shape and size of the projected images.

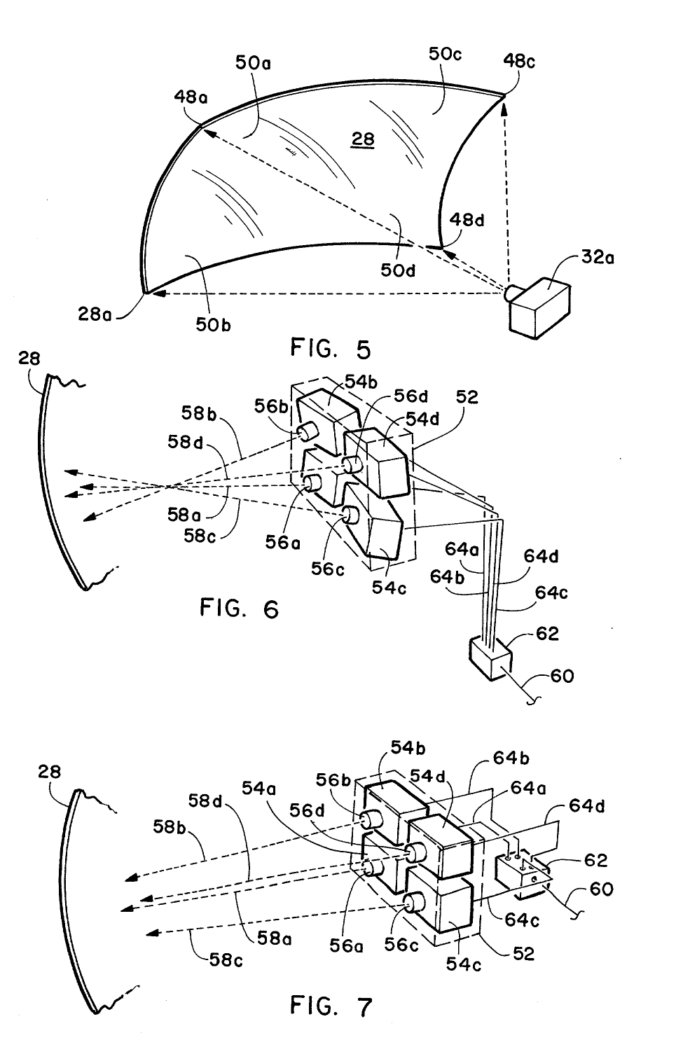

The dimensions and arcuate surface of the port side projection screen 28a, along with the relative distances between the projection screen 28a and projection apparatus 32a is shown in the isometric view in FIG. 5. In the preferred embodiment shown, the projection screen 28a is defined by four corners: upper left corner 48a; lower left corner 48b; upper right corner 48c; and lower right corner 48d. The distance between the upper left corner 48a and the upper right corner 48c is preferably 44 feet in length, and the distance between the upper left corner 48a and lower left corner 48b is preferably 33 feet in length. Further, the distance between the projection apparatus 32a, and 1) the upper left and right corners 48a,c; and 2) lower left and right corners 48b,c; is approximately 43 feet and 49 feet respectively. For illustration purposes, the projection screen 28a is broken into four equally dimensioned quadrants as herein defined: upper left quadrant 50a; lower left quadrant 50b; upper right quadrant 50c; and lower right quadrant 50d. Since the airship is symmetrical, the same dimensions are applicable to the starboard side.

Turning to FIGS. 6 and 7, the components of the projection apparatus 32 are more clearly set forth. Due to the large area of the projection screen 28, as well as desired distance that the airship or balloon display must be visible from the ground, the illumination power of a typical commercially available light-weight projector is insufficient for use in this environment. An illumination power of 20-25 foot-lamberts or greater is preferred. Accordingly, one aspect of this invention is a design for a video projection array 52 to overcome the insufficiency of illumination power. The projection array 52 is simply a particular grouping of currently available projectors which function together to create a brighter and more suitable video image. This is accomplished using two different concepts designated for purposes of this discussion as the composite image array concept and the stacked image array concept. Either or both of these concepts may be used to accomplish the objectives of the present invention.

The composite image array concept is best illustrated in FIG. 6. In that Figure, the projection apparatus 32 is comprised of four projector heads 54a-d, each having a respective projector lens 56a-d for projecting video images 58a-d at divergent angles to a particular quadrant 50a-d of the projection screen 28. The video image signal 60 is input into a digital video processor 62 which digitally sections the video signal into four different signals 64a-d, each signal being directed to one of the four projector heads 54a-d where the corresponding video image 58a-d is projected onto the corresponding quadrant 50a-d of the projection screen. For example, sectioned video signal 64c is received by projector head 54c and projected through lens 56c and further onto quadrant 50c of the projection screen 28. The lenses 56a-d and the orientation of the projector heads 54a-d relative to each other are adjusted so as to allow all projected video images 58a-d to seamlessly diverge to create a complete, clear and much brighter illuminated image. In the preferred embodiment, the digital video processor 62 is an Imagemag 2 manufactured by Electrosonic (tm), however many other processors are commonly available which will function in the same or similar manner.

The stacked image array concept is best illustrated in FIG. 7. In that Figure, the projection apparatus 32 is again comprised of four projector heads 54a-d, each having a respective projector lens 56a-d for projecting video images 58a-d at convergent angles to a particular quadrant 50a-d of the projection screen 28. The video image signal 60 is input into a four way splitter and amplifier 66 which splits the video signal into four identical signals 64a-d, each signal being directed to one of the four projector heads 54a-d where the corresponding video image 58a-d is projected onto the entire area of the projection screen. For example, split video signal 64c is received by projector head 54c and projected through lens 56c and further onto the entire area of the projection screen 28. The lenses 56a-d and the orientation of the projector heads 54a-d relative to each other are adjusted so as to allow all projected video images 58a-d to over-lay one another to create a clear and much brighter illuminated image. In order to project an image which fills the projection screen area while working with such a short projection distance, a special short-throw lense may be used. The splitter and amplifier 66 can be found under the part name xbvb/vda video brick manufactured by VAC Products, however there are a variety of similar devices which will serve the intended function.

Although a wide variety of alternate projectors may be utilized for both arrangements, projectors sold under the trademark Epson (tm) and Proxima (tm) have thus far produced the best result when utilized in an array having of four projectors. The following table illustrates the salient data for a typical projection array, wherein four projectors are utilized to display a video image on the envelope 12 of a typical airship, which is equivalent to a 1400 square foot side screen.

| MODEL | WATTS | LUMENS | LUX* |
|---|---|---|---|
| Proxima DP 9260 | 1200 | 10,000 | 64.30 |
| Plus | | | |
| Epson 7700P | 1140 | 12,000 | 77.14 |

Although not shown, it is to be understood that the above composite and stacked array concepts may be combined to create an even brighter illuminated display. For example, the projection array 52 may comprise eight projector heads 54, each pair of projector heads 54 directed toward one quadrant 50, and one projector head 54 of each pair projecting an image which over-lays the other. As such both concepts are utilized in the same projection array 52.

Video images can be produced in 16.7 million colors and by most any format including laptop computer, VHS player, real-time transmitted or re-transmitted televison feeds. As used herein, “video” includes cinema, slide projection, television, laser or any other means of transforming a visual image to a light pattern for remote projection toward a viewing surface. Displays can be recorded productions in full motion and can be adapted from existing commercial footage, or live productions that have been re-transmitted. The most common presentation is commercial television productions.

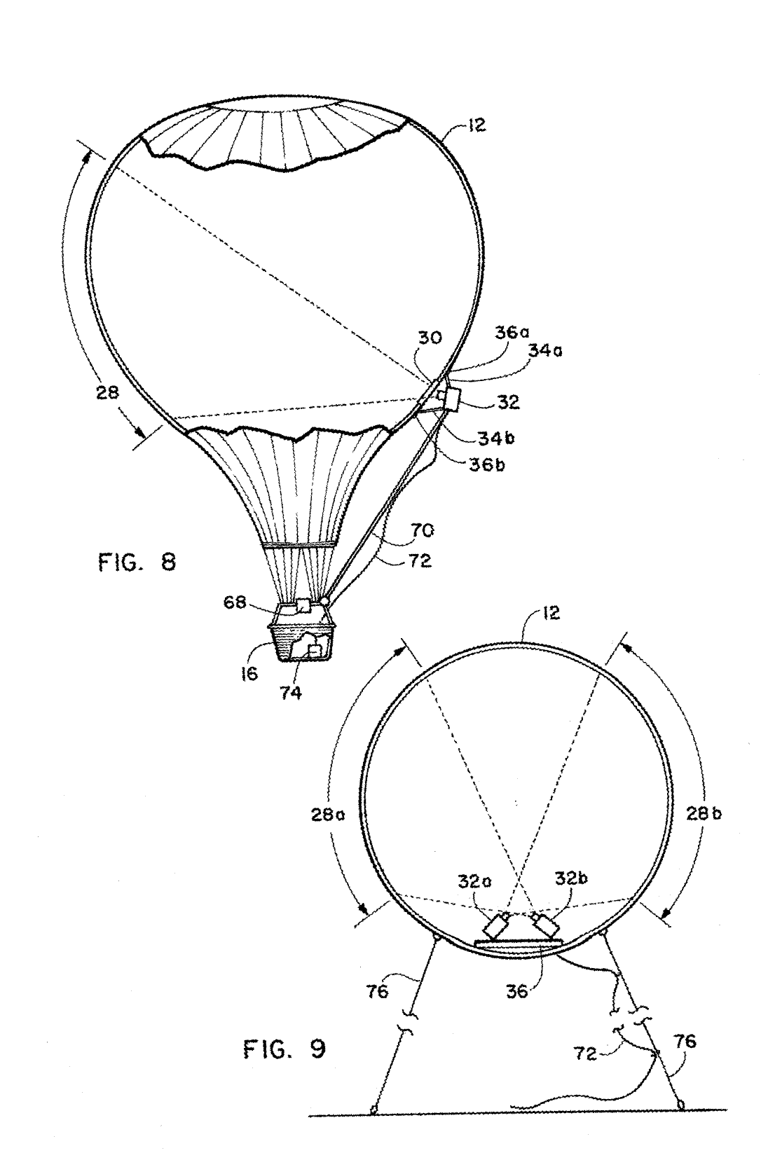

FIG. 8 illustrates another embodiment of the present invention in a typical environment for use as a video display on a hot air balloon. As used herein, “balloon” is defined as an inflatable object shaped usually like a sphere, made nonporous, and filled with heated air or a gas lighter than air. As shown, the envelope 12 of the balloon structure is formed of a translucent material capable of performing its primary intended function of containing the heated air emanating from burner 68 to give proper lift to suspend the gondola 16 above the ground, and serves a secondary and dual purpose of defining a desired projection area or projection screen 28 for receiving and projecting video or “television like” images. In this embodiment, a projection screen 28 may be located on one or more sides of the balloon structure. As set forth above, a transparent window 30 is formed in the envelope 12 for allowing the projection of images from a projector apparatus 32 to pass through the envelope 12 substantially unaltered. The projector apparatus 32 is attached to the balloon envelope 12 by way of mounting plates 36a,b, adjustable support brackets 34a,b, and a rigid stabilizing support 70 which is attached to the balloon frame as shown. The orientation of the projector apparatus 32 may be altered by adjusting the length and angle of brackets 34a,b to allow for proper and effective projection of video images onto the projection screen 28 located on the opposing side of the balloon. The projector apparatus 32 receives a video image input from a video output device 74, such as a computer, located in the gondola 16. The signal from the video output device 74 is transmitted to the projector apparatus 32 by way of data cable 72.

Turning to FIG. 9, another embodiment of the present is shown having a gas filled translucent envelope 12 suspended in the air by mooring cables 76a,b. The preferred gas is helium, although other gases may be utilized to perform the intent of the invention. In this embodiment, the projector apparatus 32a,b are mounted to the envelope 12 on the interior of the balloon, and receive video input by way of data cable 72 as shown.

While the invention has been described in connection with preferred, alternative and commercial embodiments, it will be understood that it is not intended to limit the invention thereto, but is intended to cover all modifications and alternative constructions falling within the spirit and scope of the invention as expressed in the appended claims.

I claim:

1. An image projection system for use on an inflatable structure, comprising:
a flexible material forming an inflatable volume having a predetermined surface area which defines a projection screen for receiving a video image effective for viewing from a location external to the inflatable structure, and having a transparent window formed in said flexible material on a surface of said inflatable volume opposing said projection screen; and
a projection apparatus aligned to the exterior of said transparent window for projecting a video image through said inflatable volume and onto said projection screen.

2. An image projection system of claim 1, wherein said projection screen is a plurality of projection screens, and said transparent window is a plurality of transparent windows, and said projection apparatus is a plurality of projection apparatus, such that each of said projection apparatus is aligned to one of said transparent windows and said corresponding projection screen, and said transparent windows are formed outside said predefined areas of said projection screens.

3. An image projection system of claim 1, wherein said inflatable volume is filled with hot air to provide lift into the air.

4. An image projection system of claim 3, wherein said inflatable volume is partially enclosed.

5. An image projection system of claim 1, wherein said inflatable volume is enclosed and filled with a gas having characteristics which make it lighter than air.

6. An image projection system of claim 1, wherein said inflatable volume is an envelope of an airship.

7. An image projection system of claim 1, wherein said inflatable volume is an envelope of a balloon.

8. An image projection system of claim 1, wherein said projection apparatus comprises an array of projector heads.

9. An image projection system of claim 8, wherein said array is comprised of a plurality of projector heads oriented such that each of said projectors projects a predetermined portion of an image at a predetermined area of said projection screen, such that a complete image is formed when each of said portions of said image are projected from said plurality of projector heads.

10. The image projection system of claim 8 wherein said array is comprised of a plurality of projectors oriented such that each of said projectors of said array projects an identical image at an identical location on said projection screen.

11. The image projection system of claim 1, wherein said flexible material defining said projection screen is translucent.

12. An image projection system for use on an airship structure, comprising:
an airship hull having a predetermined surface area which defines a projection screen for receiving a video image effective for viewing from a location external to the airship structure; and,
a projection apparatus mounted to an opposing surface of said hull for projecting a video image through the interior of said airship and onto said projection screen.

13. An image projection system of claim 12 wherein said projection apparatus is mounted to the external surface of said airship hull, said hull having a transparent window formed therein for allowing said video image to pass through substantially unaltered.

14. An image projection system of claim 12 wherein said airship hull is formed of a translucent material.

15. An image projection system of claim 12 wherein said projection apparatus is enclosable by an inflatable pressurized protective housing.

16. An image projection system of claim 12 wherein said projection apparatus is comprised of a plurality of projector heads to create a highly illuminated display.

17. An image projection system of claim 16 wherein said plurality of projector heads are arranged such that each of said projector heads projects a predetermined section of an image to a predefined area of said projection screen, such that a complete image is formed when each of said sections of said image are projected from said plurality of projector heads.

18. An image projection system of claim 16 wherein said plurality of projector heads are arranged such that each of said projector heads projects an identical image on the entire surface of said projection screen.

19. An aerial image projection system for use on a balloon structure, comprising:
a flexible material forming an inflatable volume having a predetermined surface area which defines a projection screen for receiving a video image effective for viewing from a location external to the balloon, and having a transparent window formed in said flexible material on a surface of said inflatable volume opposing said projection screen; and
a projection apparatus aligned to the exterior of said transparent window for projecting a video image through said inflatable volume and onto said projection screen.

20. An aerial image projection system of claim 19, wherein said inflatable volume is filled with hot air.

21. An aerial image projection system of claim 19, wherein said inflatable volume is filled with a gas having lighter than air characteristics.
